(19) United States
(12) Patent Application Publication
(10) Pub. No.: US 2026/0045759 A1
(43) Pub. Date: Feb. 12, 2026

(54) Method for Filtering in a Laser System

(71) Applicant: Robert Bosch GmbH, Stuttgart (DE)

(72) Inventors: Joern Hoffarth, Reutlingen (DE); David Copeto, Ludwigsburg (DE); Stefan Noe, Stuttgart (DE)

(21) Appl. No.: 19/289,049

(22) Filed: Aug. 3, 2025

(30) Foreign Application Priority Data
Aug. 7, 2024 (DE) 10 2024 207 471.3

(51) Int. Cl. H01S 3/13; G01S 7/481

(52) U.S. Cl. CPC H01S 3/13; G01S 7/4814

(57) ABSTRACT

A method for filtering in a laser system includes (i) defining at least two configurations for filtering by a measurement controller of the laser system, wherein the at least two configurations indicate different values for at least one configuration parameter for filtering, (ii) determining at least one characteristic of a laser of the laser system, and (iii) selecting a respective defined configuration based on a result from determining the at least one characteristic. A computer program, an apparatus, and a storage medium for this purpose is also disclosed.

This application claims priority under 35 U.S.C. § 119 to application no. DE 10 2024 207 471.3, filed on Aug. 7, 2024 in Germany, the disclosure of which is incorporated herein by reference in its entirety.

The disclosure relates to a method for filtering in a laser system. The disclosure further relates to a computer program, an apparatus, and a storage medium for this purpose.

### BACKGROUND

In modern laser applications widely used in areas such as industrial manufacturing, medical technology, telecommunications and scientific research, precise regulation of the laser parameters is critical to the performance and reliability of the laser system. Interference and noise in the measurement signals as well as a vibrating of the laser may affect control accuracy. The use of filters enables the efficient removal of undesirable signal fractions, which can improve the quality of the control variables. By filtering, more precise and stable control can thus be realized.

### SUMMARY

The subject-matter of the disclosure is a method, a computer program, a device, and a computer-readable storage medium having the features set forth below. Further features and details of the disclosure will emerge from the description and the drawings. Features and details which are described in connection with the method according to the disclosure naturally also apply in connection with the computer program according to the disclosure, the apparatus according to the disclosure, and the computer-readable storage medium according to the disclosure, and vice versa in each case, so that a reciprocal reference is always possible with regard to the disclosure of the disclosure.

The subject matter of the disclosure is in particular a method for filtering in a laser system, comprising the following steps, wherein the steps may be repeated and/or performed sequentially. For example, the laser system may be a laser rangefinder. The filtering may be analog and/or digital filtering, particularly a low-pass filter, and may be performed using a filter, particularly an analog or digital filter.

In a first step, preferably at least two configurations for filtering are defined by a measurement controller of the laser system, wherein the at least two configurations indicate different values for at least one configuration parameter for filtering. In other words, the values of the at least two configurations differ from each other in terms of the at least one configuration parameter. For a plurality of configuration parameters, a difference may be provided between configurations for at least one configuration parameter or for a plurality of configuration parameters. For example, the at least one configuration parameter may be a filter bandwidth, a gain factor, and/or a control frequency.

In a further step, preferably at least one characteristic of a laser of the laser system is determined. For example, the at least one characteristic may represent a stability of the laser. Furthermore, the at least one characteristic may represent a number of modes, a current demand of the laser system, periodic fluctuations in an output power (ripple) of the laser system, and/or speckle. “Speckle” refers in particular to a grain pattern that occurs when coherent light (such as that from a laser) meets a rough surface or scatters through a medium with irregularities. The resulting interference of the reflected or scattered light waves, for example, produces a random, speckled pattern. For example, the stability may be determined based on an oscillation and/or noise in a signal specific to a laser power of the laser or a light emission of the laser. For example, different levels of oscillation and/or noise could be specific for corresponding stability levels, or for stability or instability.

In a further step, preferably a respective defined configuration is selected based on a result from determining the at least one characteristic, and is preferably also further applied. The application may indicate that the respective values of the defined configuration are used for filtering. In other words, a filter used for filtering may be parameterized according to the selected configuration. Thus, advantageously dynamically, based on the at least one characteristic, filtering can be performed with the particular configuration. For example, it may be provided that low filtering is applied in the case of low stability, i.e., a high vibration of the laser, for example a low filter bandwidth, a high gain factor and/or a high control frequency, and vice versa in the case of high stability.

According to a further possibility, it can be provided that the method further comprises the following step:
defining at least one threshold with respect to the at least one characteristic of the laser.

The selection may then be performed based on a comparison of the determined at least one characteristic to the defined at least one threshold value. For example, a configuration for a range below a respective threshold value and a further configuration for a range above the respective threshold value could be provided and selected accordingly. Any number of threshold values and corresponding ranges of the configurations above and below the threshold values can be defined. Thus, advantageously suitable configurations for the different ranges below or above the at least one threshold value can be determined and selected.

It is further contemplated that a correlation between the at least one characteristic and the at least one configuration parameter is defined to dynamically perform the selection based on the defined correlation. For example, this may be performed using a mathematical formula representing the correlation. Thus, advantageously, the dynamic selection of the defined configuration may be performed even more precisely and in a more differentiated manner.

It can further be advantageously provided that the method further comprises the step of:
defining a time period, during which selecting is not performed.

The time period may comprise a settling time, or hysteresis, of the laser. This settling time may be determined for this purpose in advance based on corresponding measurements. Thus, advantageously, the initial settling time may first be overridden by a corresponding rapid control mechanism before selection of the configurations takes place. According to another possibility, instead of a fixed time period, a command may be defined that first activates a change in the configurations, i.e. the selection.

Another object of the disclosure is a computer program, in particular a computer program product, comprising instructions which, when the computer program is executed by a computer, cause the computer to carry out the method according to the disclosure. The computer program according to the disclosure thus brings with it the same advantages as have been described in detail with reference to a method according to the disclosure.

The disclosure also relates to an apparatus for data processing which is configured so as to carry out the method according to the disclosure. The apparatus can be a computer, for example, that executes the computer program according to the disclosure. The computer can comprise at least one processor for executing the computer program. A non-volatile data memory can be provided as well, in which the computer program can be stored and from which the computer program can be read by the processor for execution. The device may also be an analog discrete electronic circuit or an integrated electronic circuit configured to perform the method according to the disclosure.

The disclosure can also relate to a computer-readable storage medium, which comprises the computer program according to the disclosure and/or commands that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method. Alternatively or additionally, at least one of the disclosed method steps may be computer-implemented and/or performed automatically.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. The figures show:

FIG. 1 a schematic visualization of a method, a device, a storage medium, and a computer program according to exemplary embodiments of the disclosure, and

FIG. 2 a schematic illustration of a laser system according to exemplary embodiments of the disclosure.

### DETAILED DESCRIPTION

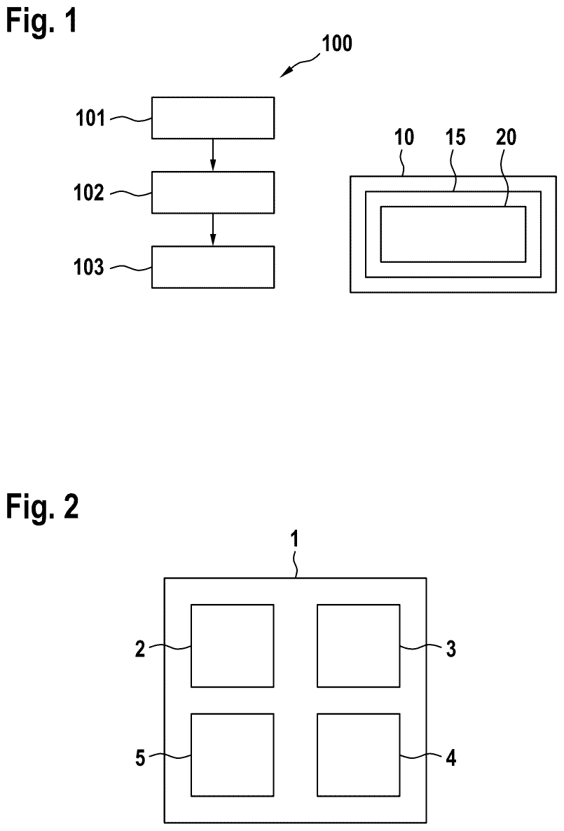

FIG. 1 schematically illustrates a method 100, a device 10, a storage medium 15, and a computer program 20 according to exemplary embodiments of the disclosure.

In particular, FIG. 1 shows a method 100 for filtering in a laser system 1. In a first step 101, at least two configurations for filtering are defined by a measurement controller 2 of the laser system 1, wherein the at least two configurations indicate different values for at least one configuration parameter for filtering. In a second step 102 at least one characteristic of a laser 3 of the laser system 1 is determined. In a third step 103, a respective defined configuration is selected in based on a result from determining 102 the at least one characteristic.

The method of the present disclosure relates to a laser system 1, and according to exemplary embodiments, in particular to a laser rangefinder that uses the indirect Time of Flight (iToF) measurement method. For this exemplary embodiment, reference is made to FIG. 2. For example, this laser rangefinder 1 operates by measuring a phase shift of a modulated light signal emitted by the laser rangefinder and reflected by a target object. The following is a description of how the Indirect Time of Flight (iToF) measurement works. First, a laser 3 in the laser rangefinder 1 can transmit intensity-modulated light, for example in the infrared or visible area, towards a target object. The modulation is in particular carried out with a sinusoidal or square wave. The intensity-modulated light subsequently strikes the target object and is reflected back to the laser rangefinder 1. A detector 4 in the measuring device can now receive the reflected light. Since the light takes a certain amount of time to travel the distance, there is a phase shift between the transmitted signal and the received signal. This phase shift between the transmitted signal and the received signal may then be measured. This phase shift is in particular proportional to the distance of the light traveled. The distance may then be calculated from the phase shift taking into account the wavelength of the modulation and the speed of light. It may further be provided that a reference phase is determined with a second detector having a constant distance (not shown) to determine the phase shift based on a comparison to the reference phase.

The laser rangefinder 1 may comprise a measurement controller 2. The measurement controller 2 in particular assumes control of the laser 3.

Thus, the measurement controller 2 may control an emission of the laser 3 by controlling switching the power on and off, as well as controlling intensity of a laser beam of the laser 3. This can ensure that the laser beam is transmitted at the correct power and with the correct characteristics.

Furthermore, a laser beam of the laser system 1 may be modulated, for example in the form of pulsed light and/or a continuous wave of variable modulation frequency. Upon receipt by the detector 4 of at least a fraction of the transmitted laser beam (for example a photodiode), the measurement controller 2 may process the received signal. This includes, for example, amplification, filtering and conversion of the received analog signal, i.e. in particular the intensity signal of the laser, into a digital signal for further analysis, in particular by an analog-digital converter 5. Furthermore, the phase shift between the transmitted signal and the received signal may be measured and optionally compared to the reference phase.

The measurement controller 2 may also periodically perform calibrations to ensure that the measurements are precise. For this purpose, it can monitor a state of the laser 3 and the detector 4 to ensure that they are functioning properly.

In addition, the laser system 1, in particular the laser rangefinder, can comprise an analog-digital converter 5. The analog-digital converter 5 preferably converts analog signals received from the detector 4 into digital signals. In particular, these signals represent an intensity of light transmitted by the laser 3. The digital conversion may allow the phase shift between the transmitted signal and the received signal to be analyzed. The digital signals provided by the analog-digital converter 5 may be further filtered, amplified, and processed to reduce noise and improve signal quality.

The two sets of configurations allow the measurement controller 2 to switch upon reaching a defined threshold value. If interferences are too large with slow, precise control according to a first configuration, preferably starting from a further threshold value, the measurement controller 2 switches back to rapid, inaccurate control according to a second configuration. The configurations include, for example, a filter bandwidth, a gain factor, and/or a control frequency.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for filtering in a laser system, comprising:
defining at least two configurations for filtering by a measurement controller of the laser system, wherein the at least two configurations indicate different values for at least one configuration parameter for filtering;
determining at least one characteristic of a laser of the laser system; and
selecting a respective defined configuration based on a result from determining the at least one characteristic.

2. The method according to claim 1, wherein the at least one configuration parameter is a filter bandwidth, a gain factor, and/or a control frequency.

3. The method according to claim 1, wherein the at least one characteristic represents a stability of the laser, a number of modes, a current demand of the laser system, periodic fluctuations in an output power of the laser system, and/or speckle.

4. The method according to claim 1, further comprising defining at least one threshold value with respect to the at least one characteristic of the laser, wherein:
the selecting is performed based on a comparison of the determined at least one characteristic to the defined at least one threshold value.

5. The method according to claim 1, wherein a correlation between the at least one characteristic and the at least one configuration parameter is defined to dynamically perform the selecting based on the defined correlation.

6. The method according to claim 1, further defining a time period during which selecting is not performed.

7. The method according to claim 1, wherein the laser system is a laser rangefinder.

8. A computer program, comprising instructions that, when the computer program is executed by a computer, cause the computer to carry out the method according to claim 1.

9. A device for data processing, configured to carry out the method according to claim 1.

10. A computer-readable storage medium, comprising instructions which, when executed by a computer, cause it to carry out the steps of the method according to claim 1.
